(19) United States
(12) Patent Application Publication
(10) Pub. No.: US 2001/0033475 A1
(43) Pub. Date: Oct. 25, 2001

(54) Thermally efficient portable computer system incorporating thermal connection port and dock

(76) Inventors: Tony J. Lillios, Palo Alto, CA (US); William Kevin Kotzman, Los Angeles, CA (US); Christopher Vaughan Muchmore, Belmont, CA (US); Ryan Mongan, San Carlos, CA (US); Craig Janik, Los Altos, CA (US)

Correspondence Address: Alan A. Limbach, Limbach & limbach L.L.P., 2001 Ferry Building, San Francisco, CA, 94111, US

(21) Appl. No.: 09/731,376

(22) Filed: Dec. 5, 2000

Related U.S. Application Data
(63) Continuation-in-part of application No. 09/045,264, filed on Mar. 20, 1998, now abandoned.

(51) Int. Cl. G06F 1/20

(52) U.S. Cl. 361/687

(57) ABSTRACT

A portable computer system comprising a portable computer mechanically, electrically, and thermally connected to a dock is shown. The portable computer comprises a base assembly containing a microprocessor, media, batteries, and keyboard, and an internal heat moving apparatus thermally connected to the microprocessor. The dock includes a housing with a plurality of connectors and a thermal dissipation apparatus. A thermal connection is made between the portable computer and the dock through a thermal connector port located at the rear of the portable computer base and at the corresponding location on the dock. The portable computer also contains a thermal state monitor and controller subsystem. When the portable computer is connected to the dock, heat is moved from it to the dock via the heat moving apparatus and the thermal state monitor and controller subsystem permits the microprocessor to run at a fast clock-speed. The dock may also contain a thermo-electric unit which increases the amount of heat that can be dissipated in the dock. The thermal connector utilizes thermally conductive springs, or an H-shaped cavity and H-shaped plug, to conduct heat from the portable computer.

### FIELD OF THE INVENTION

This invention relates generally to the field of portable computers, and more specifically to a design for laptop and notebook computers and associated port replicators, and bus expansion docks, wherein a thermal connection is made between the portable and the attached dock for purposes of removing heat from the portable.

### DEFINITIONS

The term portable computer includes laptops and notebook computers, and some Personal Digital Assistants. Typically, these computers have a flat-panel display connected to a base by a hinge. The display is shut for transport or storage, and rotated open for use. The base may contain an integral or removable keyboard on the top surface, electronic components, printed-circuit boards, storage media, batteries, and other components. A portable computer may also feature other user-interface systems, such as a pen-based interface as in a tablet configuration, instead of, or in addition to, a keyboard.

A subnotebook computer is defined as a portable computer that is de-featured to make it substantially smaller in some dimension, usually in thickness. This smaller size makes it more convenient to transport. Typically, subnotebooks do not contain a removable media drive such as a floppy drive, or other components that are less frequently used.

A Personal Digital Assistant (PDA) is defined as a computing device that is greatly de-featured and much smaller in size than a portable computer. Some PDAs may fit inside a shirt pocket. Typically, PDAs provide much less computing performance and are considered special purpose computing devices.

A dock, including expansion docks, docking stations, and port replicators, is defined as an apparatus to which a portable computer is electrically and mechanically connected, for purposes of expanding the computer's utility. Docks typically increase the number of communication and expansion ports for networking and adding peripheral components such as external drives, removable media drives, graphics cards and the like.

An office environment is defined as a continuously utilized work site where a portable computer user has access to some or all of the following: desk space, AC power, networks and other communication lines, and computer peripheral devices such as printers.

### BACKGROUND OF THE INVENTION

The rapid growth of the portable computer market demonstrates that computer users prefer the freedom to work in different locations that these computers afford. Increasingly, portables are being purchased by both individuals and large firms as desktop replacement computers. As a result, there is a need for portables that can provide performance comparable to desktop models. Many portable owners use the machine a majority of the time in an office environment. Often the portable is connected to a dock. Many users have a home office that constitutes an office environment. Use outside of an office environment may include working at various locations in the home, on a plane, or in hotel rooms.

Computing performance is mainly considered to be the speed by which the central processing unit (CPU) can execute numerical computations, although the speed of access to data stored in disk drives is also a widely used performance criteria. For any given circuit architecture, speed is governed mainly by the clock-speed of a microprocessor. In fact, computer models are marketed in large part by the speed rating, in megahertz, of the main system clock. High performance portable computers may also include the ability to handle a range of media types such as high capacity hard disk drives, CD-ROMs, or DVDs; fast, high-resolution video processing; and connectivity functionality provided by networking and other ports.

Unfortunately, there is a problem combining all of these components into a single, small enclosure. As the system tends toward thermal equilibrium, the thermal sum of the components raises the temperature above the manufacturer's specified operating temperature limits of some or all of the components. CPUs in particular have a proportional relationship between processing power and thermal output. In order to cool these devices, portable computers must include a combination of heat moving and dissipating components such as fans, planar heat spreaders, heat exchangers, heatpipes, and heatsinks.

The size and weight of portable computers are some of the most important performance constraints. Given similar computing performance features, users prefer to purchase the product with the smallest form factor and lightest weight. In fact, many consumers make the purchase decision based on the advertised length, width, and thickness dimensions of the product. Therefore, it is undesirable to have to include the various heat dissipating components mentioned above.

As a result of these forces, portable computers are nearing the limit of the amount of heat that can be dissipated from a given volume associated with the portable. Subnotebooks are especially constrained in terms of the amount of heat removing components that can be contained in them and still meet subnotebook size requirements. The cooling problem is exacerbated by the fact that the external surfaces that are the most efficient for natural convection heat transfer, the horizontal top and vertical surfaces, cannot be used because the user can touch them. Excessive temperatures on these surfaces would cause discomfort or injury if the user came in contact. Furthermore, there is a UL touch temperature limit for plastic surfaces that manufacturers usually do not exceed.

There are two common strategies for dealing with the high thermal loads in portable computers. The first method involves a control system by which the thermal output of the microprocessor is reduced by throttling back the clock-speed of the microprocessor. The second method is to dissipate the heat with some combination of the devices mentioned above such as fans, heatpipes, heatsinks, and the like. Some manufacturers use a combination of these two strategies.

To increase the amount of dissipation, active solutions using fans and forced air convection in addition to heatpipes and heat sinks, have become popular. Larger fans require more space for the fan and for the airflow required to remove the energy. As the dissipation limit for a given volume is reached, the component cost and additional size and weight become prohibitive.

U.S. Pat. No. 5,664,201 to Ikedea et al (1997) is an example of a microprocessor throttle strategy. Ikedea et al disclose a system whereby microprocessor temperature is continuously measured and this information is fed into a control system that limits the thermal output of the microprocessor based on its temperature. This method by itself is a means for protecting a microprocessor from producing errors or damaging itself by creating more heat than the system can dissipate. There are many other implementations for measuring the thermal output of an integrated circuit or an electronic device, and thereby controlling the functions of the device to achieve a non-destructive thermal state.

The problem with simple microprocessor throttling is obvious the computational power of the computer is greatly compromised. The result is that the user experiences some fraction of the performance of the rated clock-speed of the device, during continuous operation.

U.S. Pat. No. 5,313,362 to Hatada et al (1994) is an example of a dissipation strategy being used to cool the hot components in a portable computer. Hatada et al use a series of connected planar heat spreaders to generate as much dissipation surface area as is possible. The problem is that there is a limit to the amount of heat that can be dissipated by any given volume. In order to increase heat dissipation using the Hatada et al design, the surface area of the portable must be increased, resulting in an overall undesirable increase in the size of the portable computer.

U.S. Pat. No. 5,552,960 to Nelson et al (1996) discloses a collapsible heat sink for dissipating heat generated by the hot internal components of the portable computer. The problem with this design is that it adds substantial mechanical complexity, along with additional size, weight and cost, to the portable computer. This design also forces the user to angle the portable, and thus the keyboard, in order to use the heat dissipating function. This angle may be undesirable ergonomically. Furthermore, Nelson et al do not provide for an optimal heat dissipation configuration because the hot surfaces are still mainly horizontal bottom facing surfaces of the main housing. The optimal surfaces for heat dissipation are top and vertical surfaces.

In addition to the two strategies outlined above, one prior art reference, U.S. Pat. No. 5,537,343 to Kikinis et al (1997), addresses heat conduction between one computer, a PDA, placed inside of another larger computer. However, this design does not provide for the ability to operate or access the PDA when place inside the larger computer, nor does it address the problem of removing and dissipating heat for the purpose of providing increased computational performance.

What is needed is a portable computer that can be as small, light, and as inexpensive as is possible, but still be able to provide for maximum computational performance equal to desktop computers, when used in an office environment.

### SUMMARY OF THE INVENTION

The objects of the present invention are:

to provide a portable computer that can contain and operate at full power with microprocessors equal in computational power to those found in desktop computers;

to provide a portable computer that is smaller and lighter when transported, yet offers a highest level of computing performance, comparable to desktops;

to provide a portable computer that is less expensive to manufacture due to the absence of numerous and expensive internal thermal dissipation components;

to make use of the fact that portable computers are used the majority of time in an office environment where there is access to AC power with which to power an active thermal dissipation apparatus;

to make use of the fact that portable computers are used much of the time in an office environment, where there is more desk space available for heat dissipating apparatus;

to provide for a portable computer wherein the main heat-producing thermal components are easily interchangeable or upgradable since a substantial portion of the thermal dissipation subsystem is located external to the portable;

to provide a computer than can contain hotter components and thus provide better performance, yet maintain cooler temperatures on exposed surfaces;

to provide a portable computer that can provide a high level of processing power but which does not have to contain a noisy fan; and

to provide a computer with a thermal dissipation system that can be optimized in terms of location of components and dissipation surfaces.

The present invention provides for a portable computer system that can contain the fastest, and thus hottest, microprocessors, as fast as those found in desktop computers. At the same time the portable computers can be made smaller, lighter, and less expensive. The user can have the benefit of the fastest microprocessors when using the portable computer in an office environment where the computer is connected to a dock.

One aspect of the present invention is a computer system that includes a portable computer and a dock assembly. The portable computer includes a heat producing component and a first thermal connector thermally connected to the heat producing component. The dock assembly, which is removably engagable with the portable computer, includes a heat dissipating apparatus and a second thermal connector that is thermally connected to the heat dissipating apparatus and is removably engagable with the first thermal connector. The first thermal connector comprises one of a plug member and a first cavity, wherein the plug member has an outer surface and the first cavity has an inner surface. The second thermal connector comprises the other of the plug member and the first cavity. A first spring member is secured to one of the inner surface of the first cavity and the outer surface of the plug member such that when the first and second thermal connectors engage each other by the first cavity receiving the plug member, the first spring member contacts with, and forms a thermal connection between, the outer surface of the plug member and the inner surface of the first cavity. When the portable computer is engaged with the dock assembly, the first and second thermal connectors engage each other so that heat from the heat producing component is conducted to the heat dissipating apparatus via the first and second thermal connectors.

In another aspect of the present invention, the portable computer includes a heat producing component and a first thermal connector thermally connected to the heat producing component. The dock assembly, which is removably engagable with the portable computer, includes a heat dissipating apparatus, and a second thermal connector, thermally connected to the heat dissipating apparatus, which is removably engagable with the first thermal connector. The first thermal connector comprises one of a plug member and a cavity, wherein the plug member has an outer surface and the cavity has an inner surface. The second thermal connector comprises the other of the plug member and the cavity. The cavity includes a first and a second protrusion extending from the inner surface and into the cavity. The first and second protrusions are positioned to oppose each other so that the cavity has an H-shaped inner surface. The plug member includes a pair of prongs connected together with a cross member so that the plug member has an H-shaped outer surface, wherein when the first and second thermal connectors engage each other by the cavity receiving the plug member, the outer surface of the plug member contacts with, and forms a thermal connection with, the inner surface of the cavity. When the portable computer is engaged with the dock assembly, the first and second thermal connectors engage each other so that heat from the heat producing component is conducted to the heat dissipating apparatus via the first and second thermal connectors.

Other objects and advantages of the present invention and a full understanding thereof may be had by referring to the following detailed description and claims taken together with the accompanying illustrations. The illustrations are described below in which like parts are given like reference numerals in each of the drawings.

### BRIEF DESCRIPTION OF THE DRAWINGS

FIG. 1 is a front perspective view of the present portable computer 20 connected to portable computer dock 28;

FIG. 2 is a front perspective view of portable computer 20 with the base top housing 42 removed;

FIG. 3 is a rear perspective view of heat-moving sub-assembly 34;

FIG. 4 is a front perspective view of portable computer dock 28 with dock top housing 80 removed;

FIG. 5 is a rear exploded perspective view of thermal dissipation subassembly 32;

FIG. 6 is a perspective view of the thermal connection between dock-side thermal connector 76 and portable-side thermal connector 72.

FIG. 7 is a flowchart showing the operation of the thermal state monitoring and control subsystem 35.

FIG. 8 is a front perspective view of portable computer dock 28 with dock top housing 80 removed and showing the dock only containing thermal dissipation subassembly 32.

FIG. 9A is a front perspective view of portable computer and dock, with a first alternate embodiment of the thermal connectors of the present invention.

FIG. 9B is a perspective view of the first alternate embodiment of the portable-side thermal connector of the present invention.

FIG. 9C is a side cross-sectional view of the first alternate embodiment of the portable-side thermal connector of the present invention.

FIG. 9D is a side cross-sectional view of the conductor spring of the present invention.

FIG. 9E is a perspective view of the first alternate embodiment of the dockside thermal connector of the present invention.

FIG. 9F is a side cross-sectional view of the first alternate embodiment of the thermal connectors of the present invention.

FIG. 10A is a perspective view of the second alternate embodiment of the portable-side thermal connector of the present invention.

FIG. 10B is a perspective view of the second alternate embodiment of the dock-side thermal connector of the present invention.

FIG. 10C is a side cross-sectional view of the second alternate embodiment of the portable-side thermal connector of the present invention.

FIG. 10D is a side cross-sectional view of the second alternate embodiment of the dock-side thermal connector of the present invention.

FIG. 10E is a side cross-sectional view of the second alternate embodiment of the thermal connectors of the present invention.

FIG. 11A is a perspective view of the third alternate embodiment of the portable-side thermal connector of the present invention.

FIG. 11B is a perspective view of the third alternate embodiment of the dock-side thermal connector of the present invention.

FIG. 11C is a side cross-sectional view of the third alternate embodiment of the thermal connectors of the present invention.

FIG. 12A is a perspective view of the fourth alternate embodiment of the portable-side thermal connector of the present invention.

FIG. 12B is a perspective view of the fourth alternate embodiment of the dock-side thermal connector of the present invention.

FIG. 12C is a partial top view of the fourth alternate embodiment of the thermal connectors of the present invention.

FIG. 13A is a perspective view of the fifth alternate embodiment of the dock-side thermal connector of the present invention.

FIG. 13B is a perspective view of the fifth alternate embodiment of the portable-side thermal connector of the present invention.

FIG. 13C is a side cross-sectional view of the fifth alternate embodiment of the thermal connectors of the present invention.

### DETAILED DESCRIPTION OF THE PREFERRED EMBODIMENTS

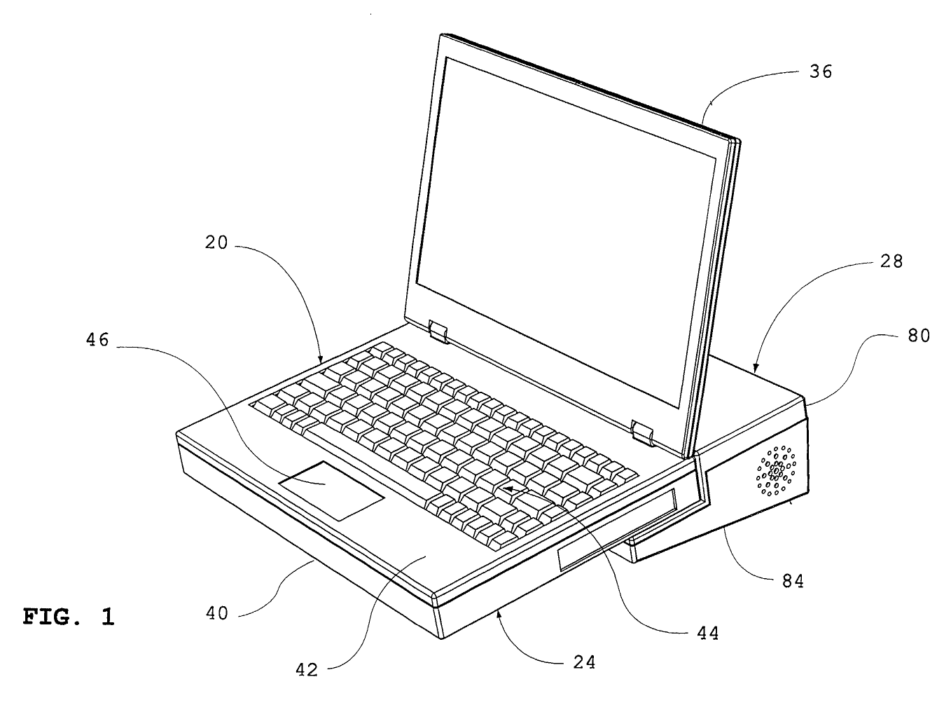

Referring to FIG. 1, a portable computer 20 connected to a portable computer dock 28 is illustrated according to the present invention. Portable computer 20 is seen to generally include a display module 36 pivotally mounted to a base assembly 24, a keyboard sub-assembly 44, and a touch-sensitive pointing device 46, used to control the on-screen cursor.

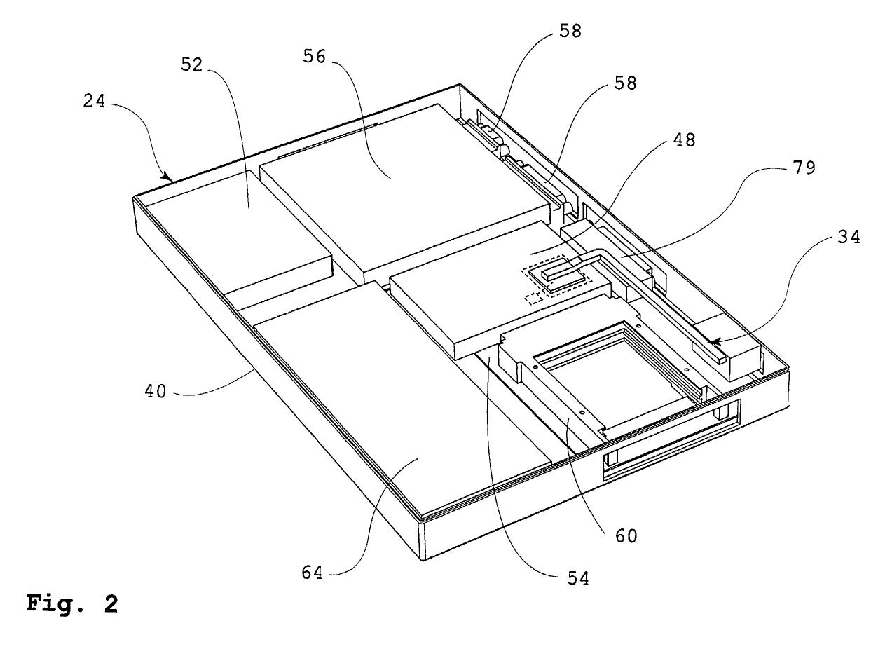

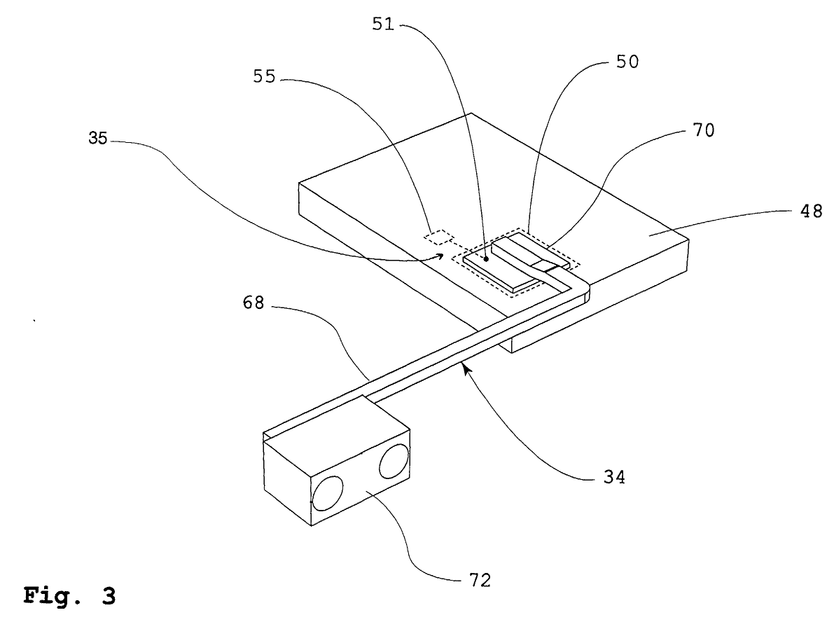

As seen in FIG. 2, base assembly 24 comprises a microprocessor module 48, a heat-moving sub-assembly 34, a hard disk drive 52, a media bay 56, a plurality of input/output connectors 58, a circuit-board 54, a PC Card connector 60, a battery pack 64, and a portable-side electrical docking connector 79. Referring now to FIG. 3, heat-moving sub-assembly 34 comprises a thermal-attachment plate 70, a heatpipe 68, and a portable-side thermal connector 72. Heatpipes move heat as a result of a phase change of a liquid contained in them and are well known in the art of portable computer design. Thermal attachment plate 70 is thermally and mechanically attached to microprocessor module 48 and heatpipe 68. The other end of heatpipe 68 is thermally and mechanically attached to portable-side thermal connector 72. As shown in FIGS. 1 and 2, all of these components are contained by a base bottom housing 40 and a base top housing 42. Base bottom housing 40 and base top housing 42 are arranged in a clam-shell configuration. It should be understood that microprocessor module 48, circuit-board 54, and input/output connectors 58 are well known in the art and are shown somewhat diagrammatically so that the detail does not obscure the present invention.

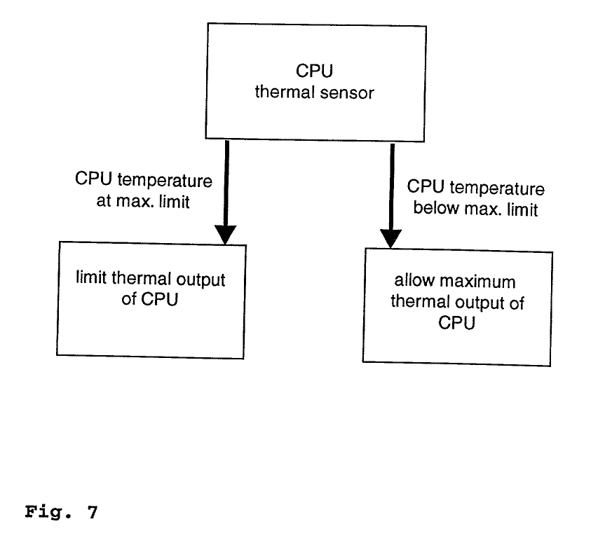

As shown also in FIG. 3, the thermal state monitor and controller subsystem 35 is comprised of a temperature monitor and controller circuit 55, electrically connected to a surface mount thermistor 51. These components are integral to microprocessor module 48 and are thus shown with dashed lines. Thermistors are resistive circuit devices whose resistance varies with temperature, and are well known in the art of temperature sensing in electronic devices. Thermistor 51 is located on the underside of an integral circuit board, directly beneath the microprocessor 50, shown with dashed lines in FIG. 3. The operation of thermal state monitor and controller subsystem 35 is described by the flow chart in FIG. 7.

As seen in FIG. 1, display module 36 has an indent near the bottom of each side that contains components to allow pivoting of display module 36 about the rear portion of base assembly 24. Pivots of this type are well known in the field of portable computer design.

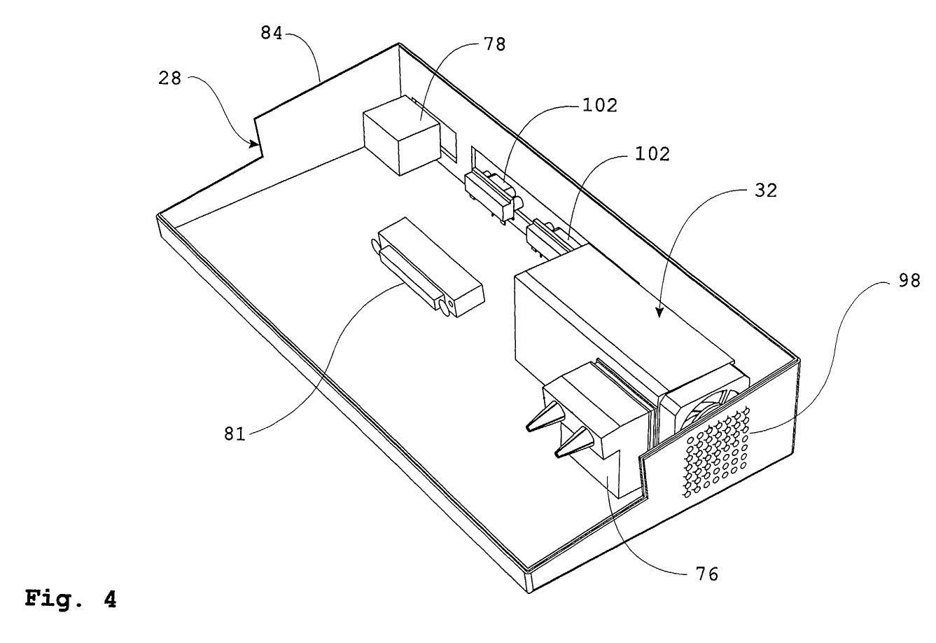

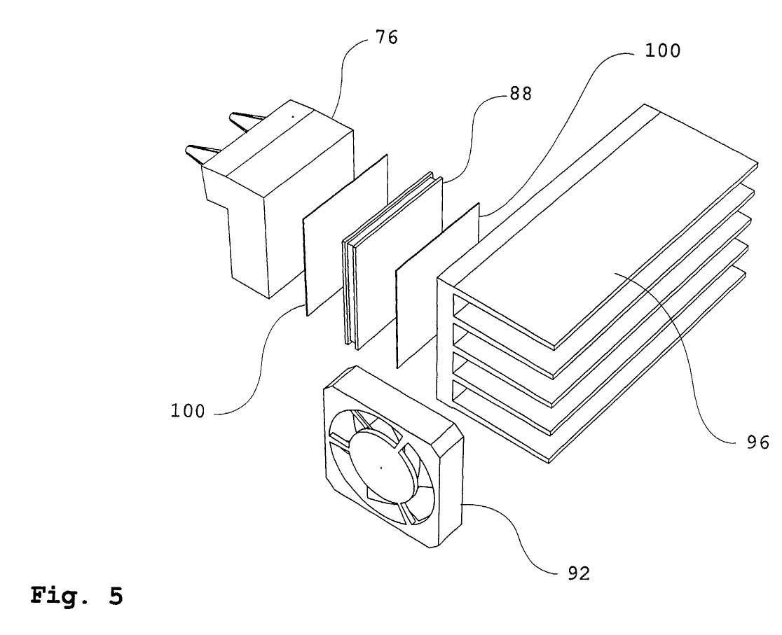

As seen in FIG. 1, portable computer dock 28 is generally comprised of a dock top housing 80 and a dock bottom housing 84. Contained in portable computer dock 28, as shown in FIG. 4, is a thermal dissipation sub-assembly 32, an AC connector 78, a plurality of expansion and input/output connectors 102, and a dock-side electrical docking connector. As shown in FIGS. 4 and 5, thermal dissipation sub-assembly 32 comprises a dock-side thermal connector 76, a thermo-electric unit 88, a heatsink 96, and a fan 92. Thermo-electric unit 88 is a thin, planar, solid-state device that utilizes the Peltier effect whereby a current is passed through the junction of two dissimilar conductors, with a resultant temperature difference in the two conductors. An example of a thermo-electric unit is model CP1.8-127-06L, provided by Melcor of Trenton, N.J. A layer of a thermal interface material 100 thermally connects the apositioned surfaces of thermo-electric unit 88 and dock-side thermal connector 76, and the apositioned surfaces of thermo-electric unit 88 and heatsink 96. Thermal interface material 100, such as Cho-Therm T710 provided by Chomerics of Woburn, Mass., is well known in the art of portable computer design. The mechanical connections between thermo-electric unit 88 and dockside thermal connector 76, and between thermo-electric unit 88 and heatsink 96 consist of threaded fasteners, but have been omitted so as not to obscure the present invention. Fan 92 is attached to the side of heatsink 96. It should be noted that dock-side thermal connector 76 is also mechanically attached to dock bottom housing 84, however, this detail has been omitted here so as not to obscure the present invention. Referring now to FIG. 4, thermal dissipation subassembly 32 is arranged so that it is contained inside of dock top housing 80 and dock bottom housing 84 when they are mated. Dock bottom housing 84 has a plurality of convection holes 98 through which heated air is exhausted by fan 92. The electrical circuits that run from dock-side electrical connector 81 to dock input/output connectors 102 are well known in the art of portable computer design have been omitted in the drawing so as not to obscure the present invention.

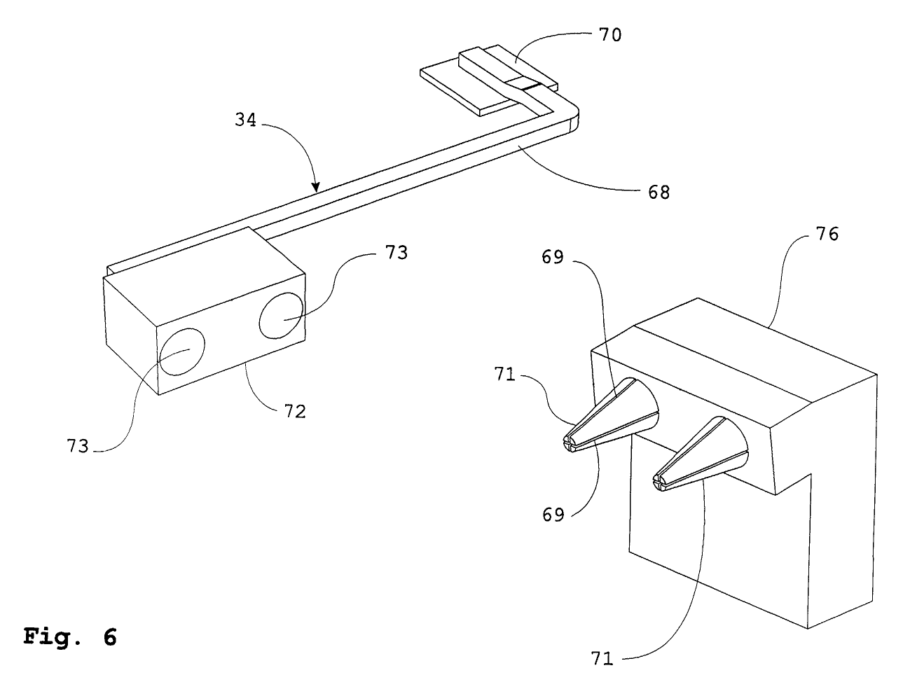

Now referring to FIG. 6, dock-side thermal connector 76 includes two thermal conduction cones 71 protruding from the front surface of vertical surface of portable computer dock 28. Each thermal conduction cone 71 is dissected with two orthogonal flexural cuts 69. Portable-side thermal connector 72, part of heat moving sub-assembly 34, includes two corresponding conical conduction cavities 73. Thermal connectors 76 and 72 can be made of any heat conducting metal or other material, such as aluminum, magnesium or carbon fiber.

Next, the operation and effect of the above embodiment in both a docked and undocked configuration will be described.

When portable computer 20 is used in a docked configuration, it is mechanically, electrically, and thermally connected to portable computer dock 28. The mechanical and electrical connections between portable computer 20 and portable computer dock 28 are well known in the art and will not be addressed here. Due to the conical geometry of the mated surfaces of thermal conduction cones 71 on the dock-side thermal connector 76, and conical conduction cavities 73 on the portable-side thermal connector 72, a large area of surface contact exists between the two connectors, allowing a substantial amount of heat flow. Also insuring maximum contact area for the thermally conductive connection between thermal conduction cones 71 and conical conduction cavities 73 are the orthogonal flexural cuts 69 in thermal conduction cones 71, which permit thermal conduction cones 71 to bend slightly to reduce small alignment gaps that might exist between the conical conduction cavities 73 and thermal conduction cones 71.

When the computer is turned on in its docked configuration, various components and subsystems inside portable computer 20 begin to produce heat due to the electrical resistance of the circuits. Initially, as shown in FIG. 7, the thermal state monitor and controller subsystem 35 senses low temperatures and allows microprocessor 50 to function at its maximum output. Controlling thermal output based on temperature sensing is well known in the field of portable computer design. The dock 28 is designed to quietly and efficiently dissipate the heat generated by portable computer 20 so that the internal temperature of portable computer 20 never reaches a state where the heat could cause malfunction or damage to any of the internal components. Microprocessor 50 functioning at its maximum clock-speed, and thus thermal output, provides a high level of computational performance for the user.

Simultaneously, thermo-electric unit 88 inside portable computer dock 28 is powered and develops a substantial temperature differential between it's front surface, which is thermally connected to dock-side thermal connector 76, and it's rear surface which is connected to heatsink 96, it's front side being much colder than it's rear side. Fan 92 forces convection over the surface of heatsink 96, thereby reducing the temperature of heatsink 96. This in turn reduces the temperature of the rear-most side of thermo-electric unit 88, causing the front side of thermo-electric unit 88 to become even colder.

Microprocessor module 48 especially produces a large amount of heat. Thus, there exists a large temperature differential between heatsink 96 and microprocessor module 48, and the heat moving components herein constitute a direct thermal connection between the two. Due to the second law of thermodynamics, heat flows from microprocessor module 48, through thermal attachment plate 70, through heatpipe 68, through the mated surfaces of portable-side thermal connector 72 and dock-side thermal connector 76, to the cold front surface of thermo-electric unit 88. The heat is transferred through thermo-electric unit 88 into the metal of heatsink 96. The heat is further dissipated to the surrounding airspace by the combination of large surface area of heatsink 96 and by the forced convection across heatsink 96 provided by fan 92. Thus, a high steady state of heat transfer is achieved, whereby the portable, when docked, can operate continuously at its full microprocessor clock-speed.

When portable computer 20 is used in an undocked situation, the thermal state monitor and controller subsystem 35 senses higher temperatures and limits the clock-speed, and thus the thermal output of microprocessor module 48, again as shown in FIG. 7. The heat output is limited to an amount that can be safely dissipated by the transfer of heat to the outer surfaces of portable computer 20.

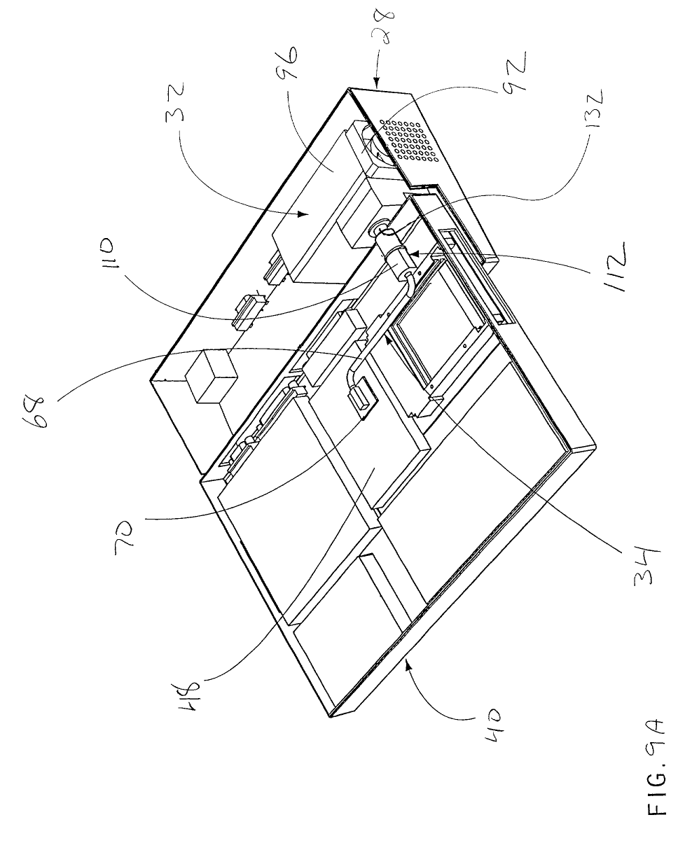

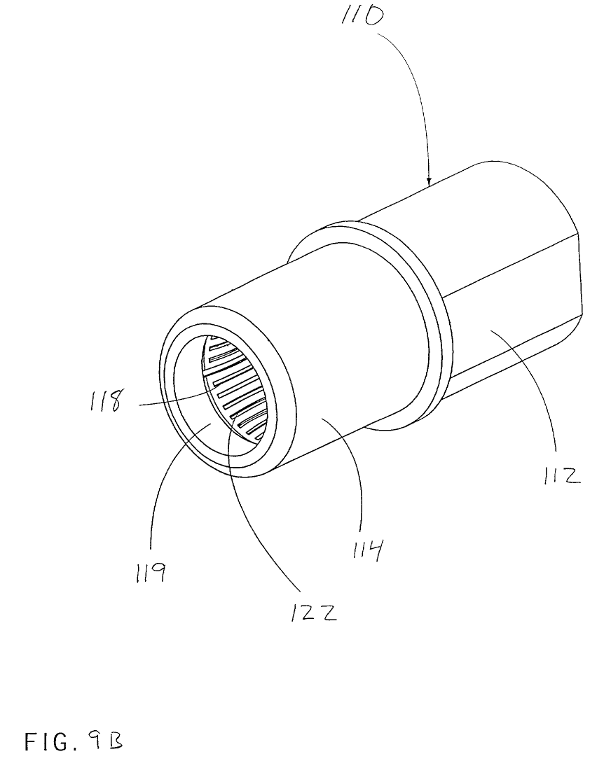

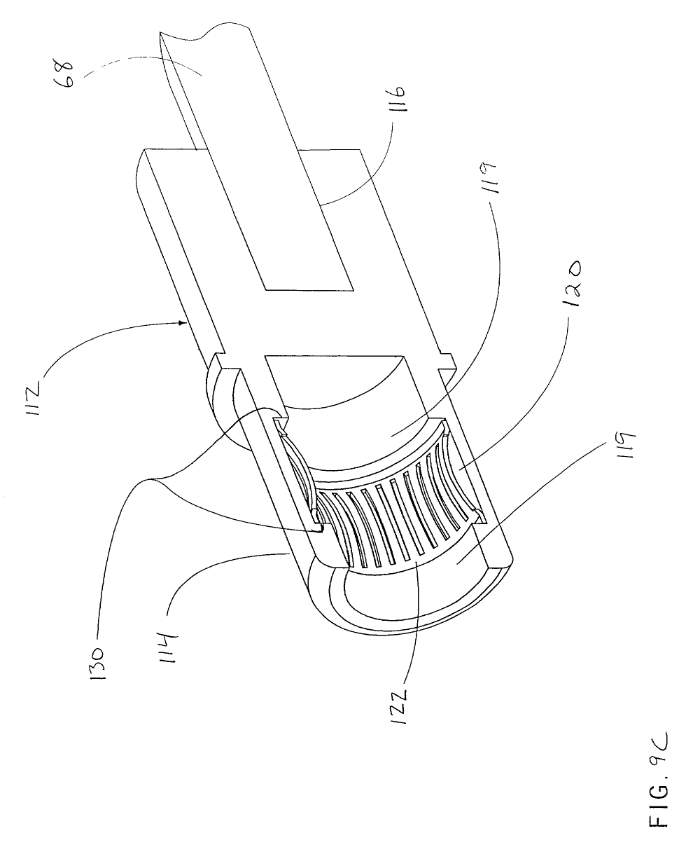

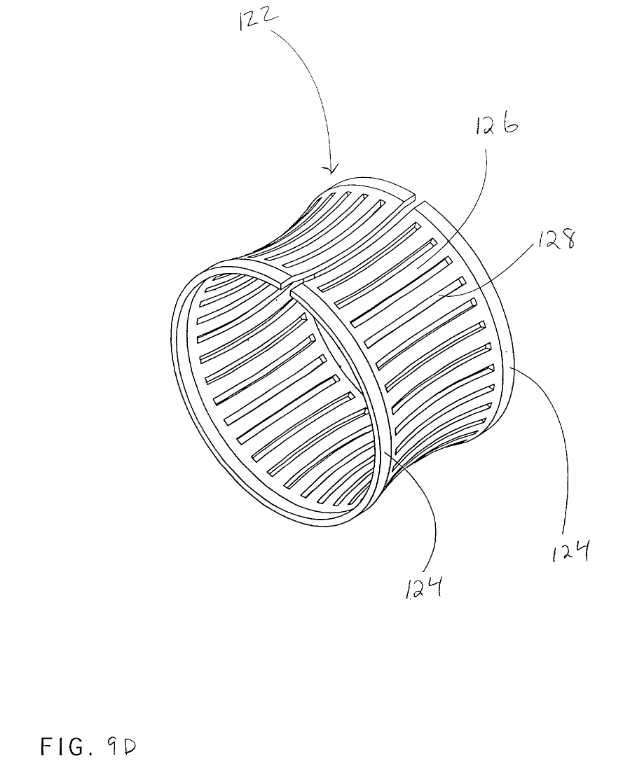

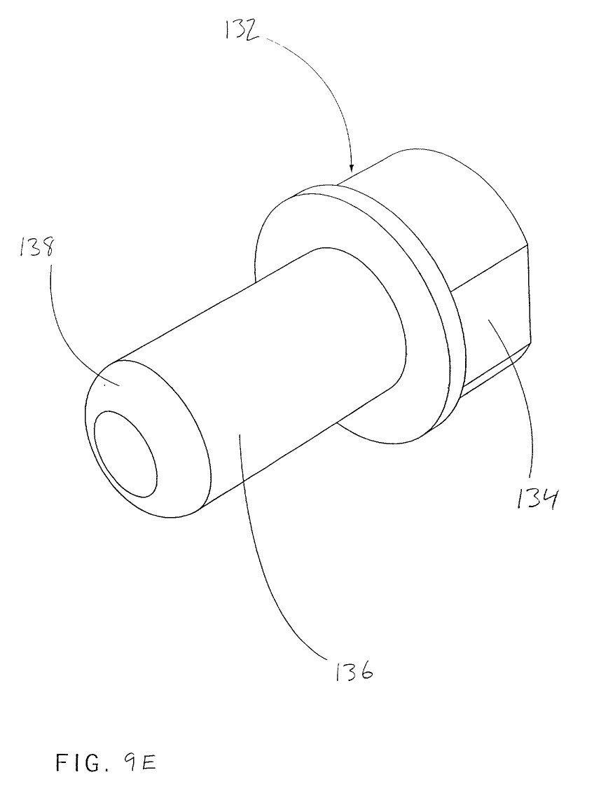

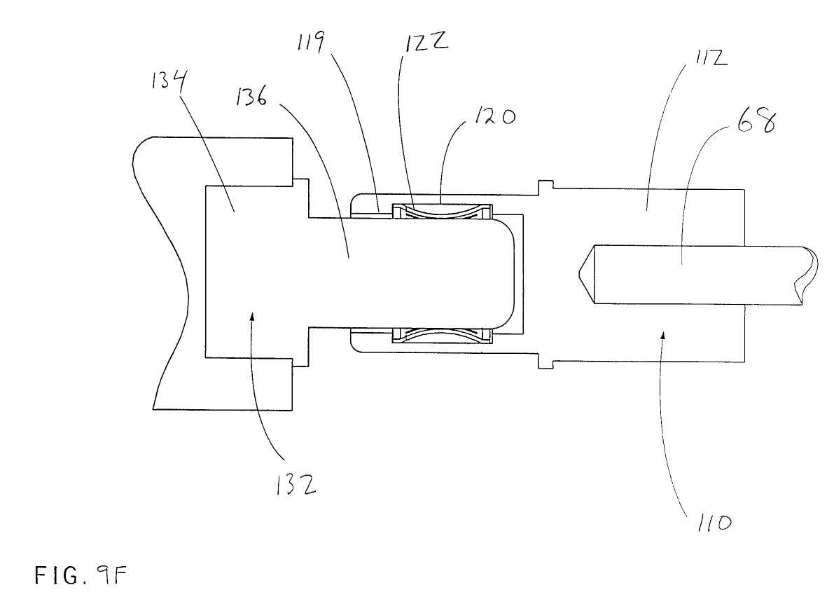

FIGS. 9A to 9F illustrate an alternate embodiment for the portable-side and dock-side thermal connectors of the present invention. In this embodiment, the portable-side thermal connector 110 includes heatpipe mounting portion 112 and a tubular protrusion portion 114. The heatpipe mounting portion 112 includes a heatpipe cavity 116, in which the heatpipe 68 is soldered. The solder acts as a gap filler to provide a very good conduction medium between the heatpipe 68 and thermal connector 10. Tubular protrusion portion 114 is hollow, and includes a main cavity 118 having an inside surface 119 that is cylindrically shaped with a first diameter. A spring channel 120 is formed in the main cavity inside surface 119, and is also cylindrical shaped with a second diameter that is concentric with, and slightly greater than, the first diameter. An annular conductor spring 122 is disposed in the spring channel 120 and is preferably made of beryllium copper. Conductor spring 122 includes a pair of annular bands 124 at its edges, and a concave annular section 126 formed between the annular bands 124. Concave annular section 126 contains a plurality of radial slots 128, where material is either removed or not formed. In its uninstalled state, the outer surface of annular conductor spring 122, measured at annular bands 124, is of a slightly larger diameter than the diameter (second diameter) of the spring channel 120. Annular conductor spring 122 is retained inside the spring channel by the edges 130 of the spring channel 120, and by the preloaded spring force exerted by the annular conductor spring 122 against the surface of the spring channel 120. Preferably thermal connector 110 is formed of solid copper or aluminum, and plated with nickel.

The corresponding dock-side thermal connector 132 includes a mounting portion 134 for thermal and mechanical attachment to the heatsink 96, and a plug member 136 for engagement with the main cavity 118. Plug member 136 extends from the mounting portion 134, has a cylindrical shape, and terminates in a radiused front edge 138 for aiding insertion thereof into main cavity 118 of thermal connector 110. Preferably dock-side thermal connector 132 is formed of solid copper or aluminum, and plated with nickel.

FIG. 9F shows thermal connectors 110/132 engaged together with plug member 136 inserted into main cavity 118, wherein concave annular section 126 of conductor spring 122 is displaced slightly by plug member 136. This displacement caused the concave annular section 126 to strain, with each piece of material in between radial slots 128 being forcibly flattened against plug member 136. Radial slots 128 allow conductor spring 122 to flexibly comply against plug member 136. The flattened material of concave annular section 126 against plug member 136 constitutes a considerable amount of surface area that is in high normal contact with plug member 136, resulting in an efficient thermally conductive coupling between conductor spring 122 and the dock-side thermal connector 132. Likewise, when plug member 136 is inserted into main cavity 118, annular bands 124 of conductor spring 122 are forced against spring channel 120, resulting in an efficient thermal conductive coupling between conductive spring 122 and portable-side thermal connector 110. Therefore, a highly conductive path can be repeatably created between the portable-side thermal connector 110 and the dock-side thermal connector 132, via the conductor spring 122.

Heat is transported from a heat source (such as a microprocessor 50) to portable-side thermal connector via the heatpipe 68. The heat flows from portable-side thermal connector 110 to dock-side thermal connector 132 via conductor spring 122, and on to heatsink 96, where it is dissipated from the portable computer dock 28 using flowing air. It should be noted that the male/female polarity of thermal connectors 110 and 132 could be reversed (i.e. thermal connector 110 could be located in the portable computer dock 28, and thermal connector 132 could be located in the portable computer 20).

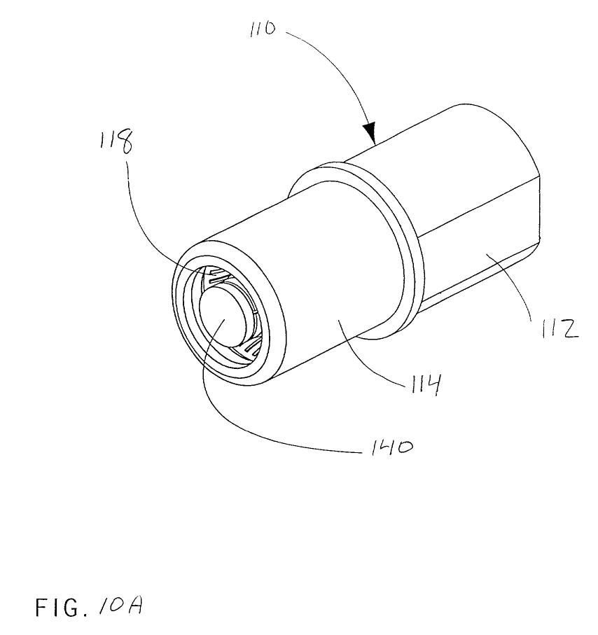

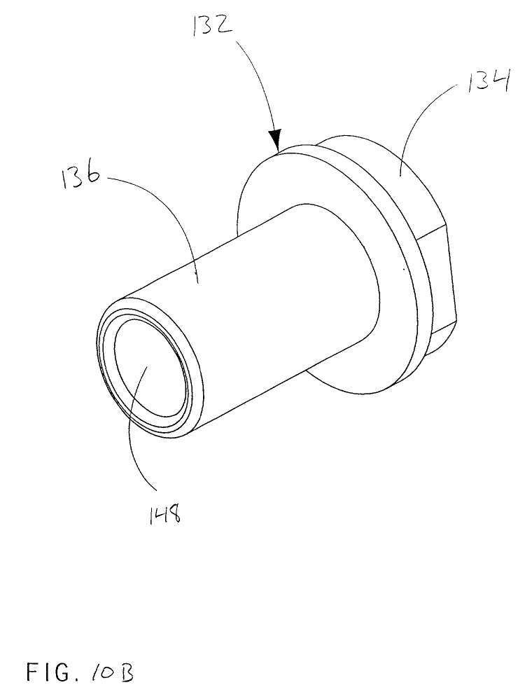

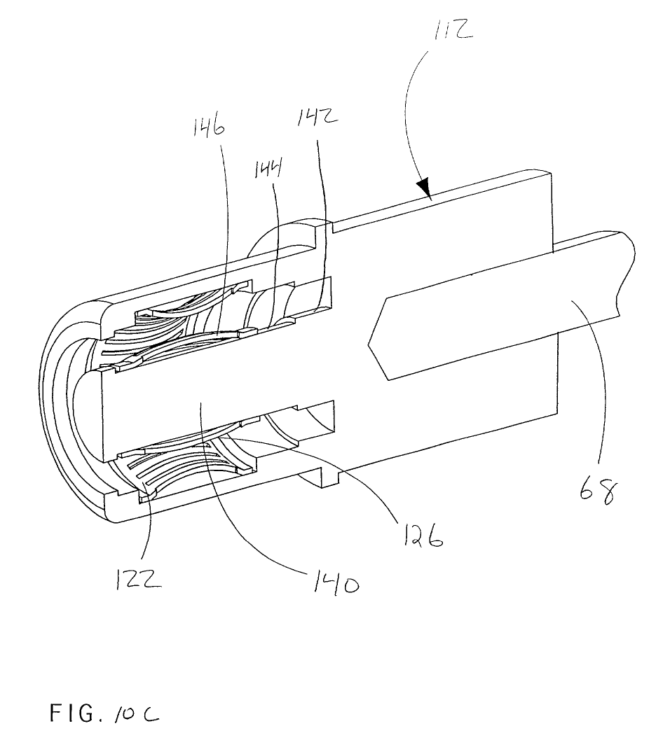

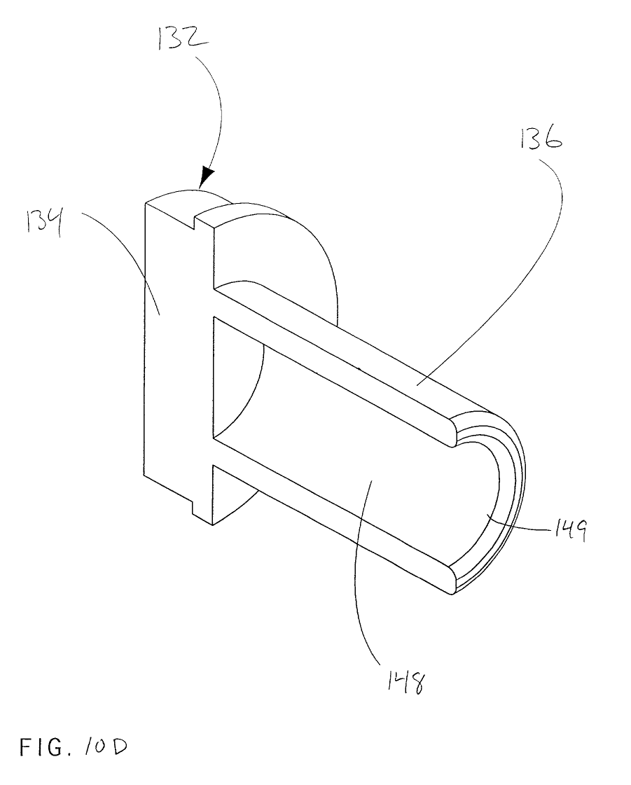

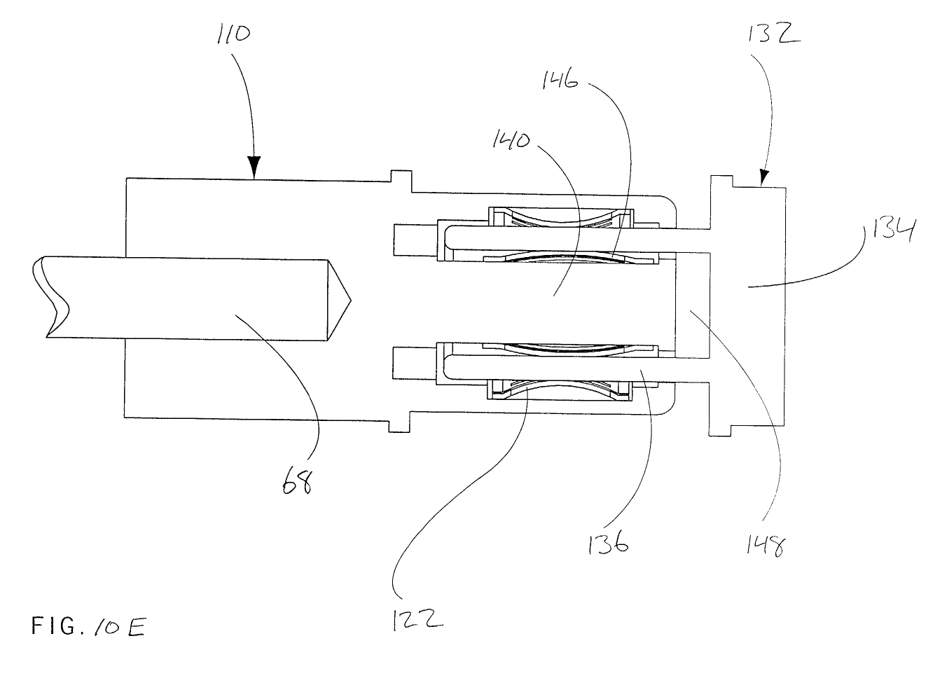

FIGS. 10A to 10E illustrate a second alternate embodiment of the present invention, which is similar to the first alternate embodiment described above and in FIGS. 9A-9F, but further including a post 140 extending down the center of the main cavity 118. Post has an outer surface 142 into which a second spring channel 144 is formed. A second annular conductive spring 146 is wrapped around post 140 and disposed in second spring channel 144. Second conductive spring 146 has a similar construction to conductive spring 122, except the annular section 126 is convex instead of concave relative to main cavity 118.

The dock-side thermal connector 132 compatible with the second alternate embodiment includes a concentric cavity 148 formed down the center of plug member 136. When thermal connectors 110/132 are engaged together, conductor spring 122 provides a strong thermal connection between the inside surface 119 of main cavity 118 and the outer surface of plug member 136, and conductor spring 146 provides a strong thermal connection between the inner surface 149 of plug member 136 and the outer surface 142 of post 140. The multiple paths of thermal conductivity provide a superior and repeatable thermal connection between the portable-side thermal connector 110 and the dock-side thermal connector 132, via the conductor springs 122 and 146.

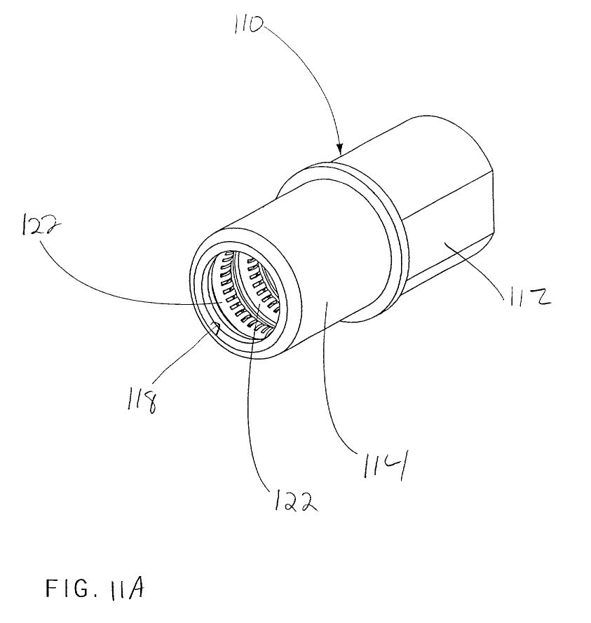

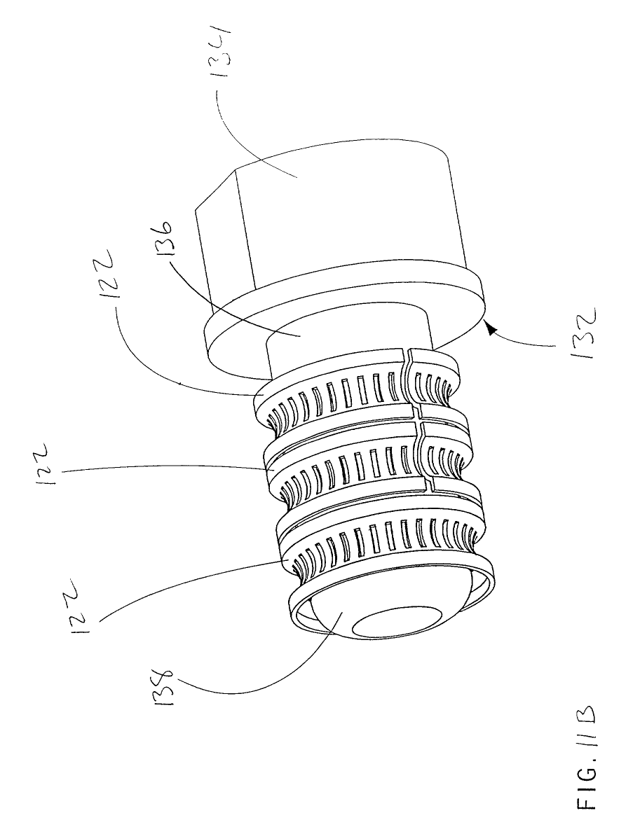

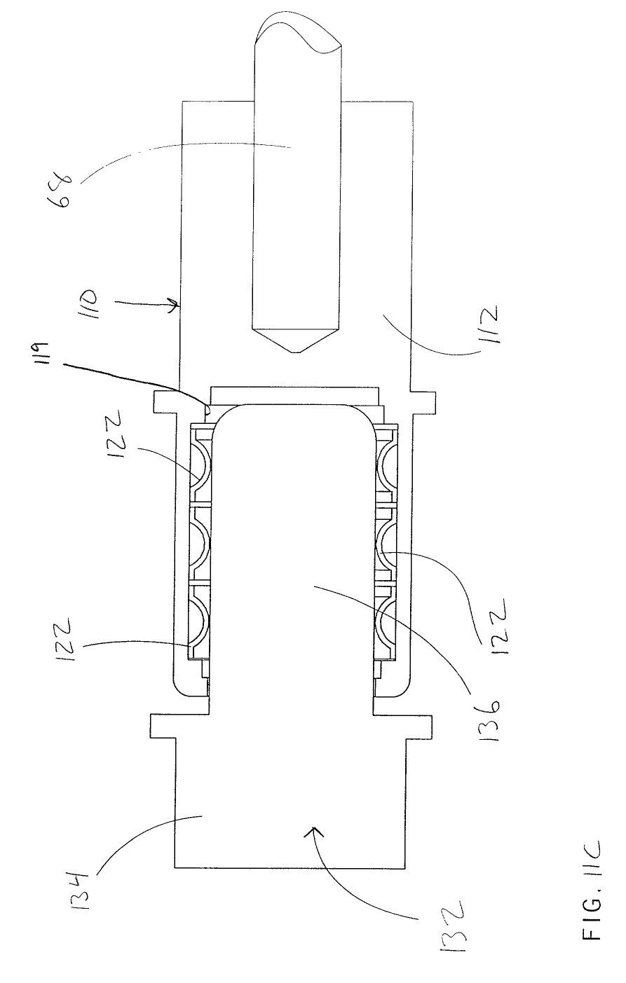

FIGS. 11A to 11C illustrate a second alternate embodiment of the present invention, which is similar to the first alternate embodiment described above and in FIGS. 9A-9F, but further including multiple conductor springs 122 disposed in multiple spring channels 120, to thermally connect the inside surface 119 of the portable-side thermal connector 110 to the plug member 136 of the dock-side thermal connector 132. The advantage of having multiple conductor springs 122 is that there is more contact area between the conductor springs 122 and thermal connectors 110/132, thus allowing a larger quantity of heat to flow therebetween.

In all these embodiments, a thermally conductive gap filling material can be used to fill the voids between portable-side thermal connector 110, dock-side thermal connector 132, and conductive springs 122/146. One such gap filling material is Chomerics T646, manufactured by Chomerics of Woburn, Mass. The conductive gap-filling material is held in place and supported by conductive springs 122/146, and can thus resist the shear forces generated by the connection and separation of thermal connectors 110/132.

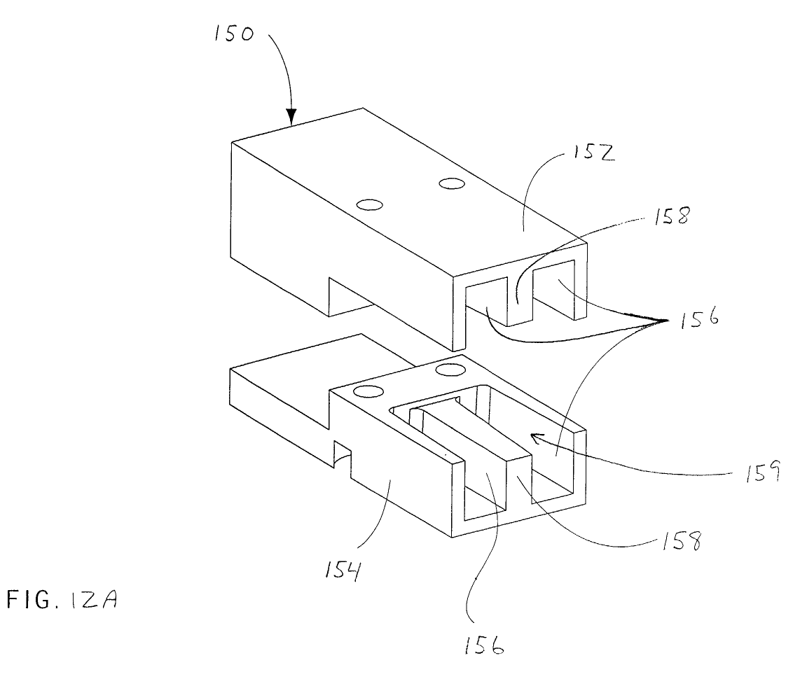

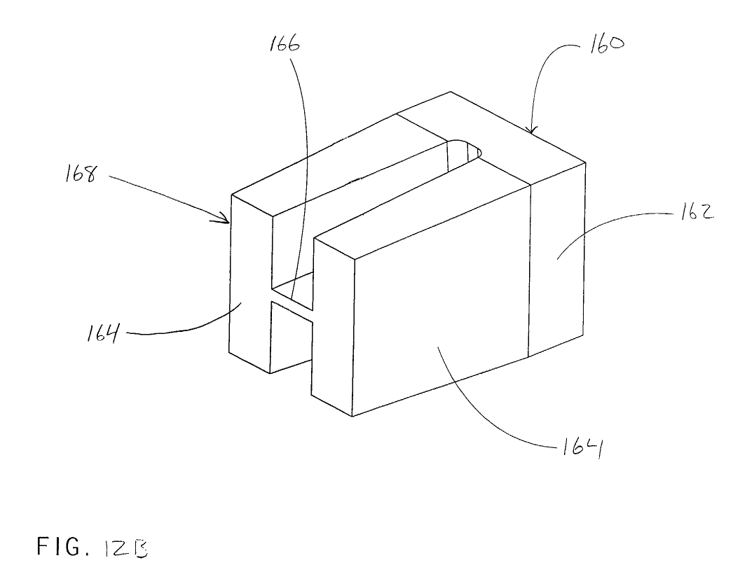

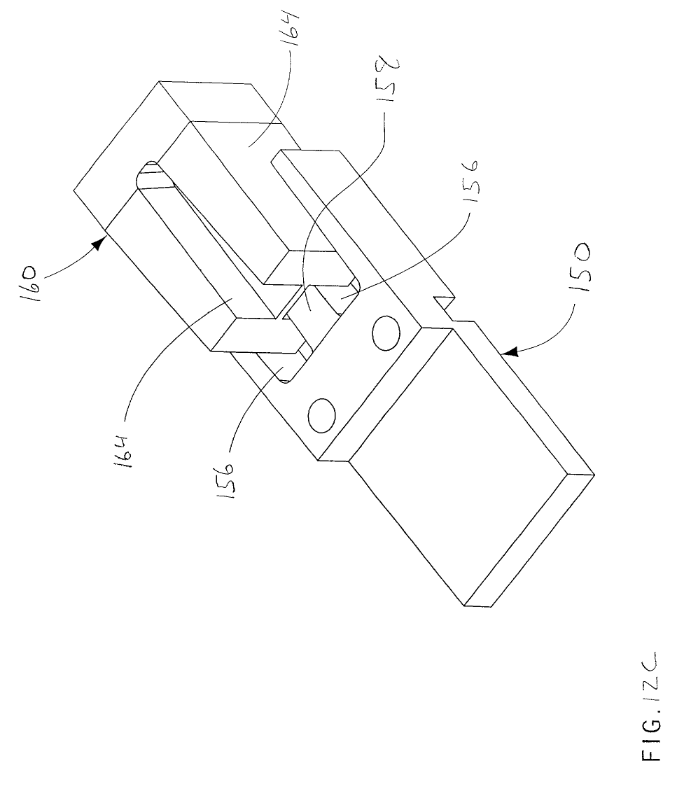

FIGS. 12A to 12C illustrate a third alternate embodiment of the present invention, where portable-side thermal connector 150 includes an upper portion 152 and a lower portion 154 that both include a pair of channels 156, open at one end, and separated by a center protrusion 158. The upper and lower portions 152/154 are fixed to oppose each other so that the channels 156 and center protrusions 158 form an H-shaped cavity 159. The compatible dockside thermal connector 160 includes a mounting portion 162 for attachment to the heatsink 96, and two rectangular protrusions 164 connected together by a cross member 166 to form an H-shaped connector 168. The surfaces of the H-shaped connector 168, and/or the surfaces forming the H-shaped cavity 159, are tapered slightly so that when H-shaped connector 168 is inserted into H-shaped cavity 159, lateral forces are created between contacting surfaces to create a superior thermal conduction connection. The advantage of this embodiment is the large amounts of surface area of the cavity 159 and connector 168 in pressure contact with each other.

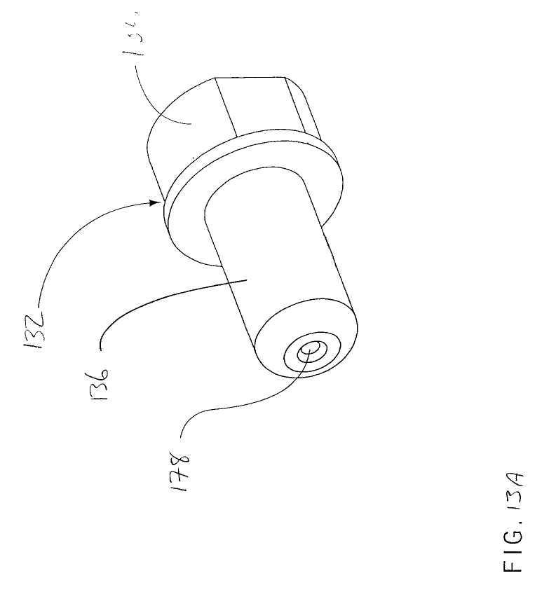

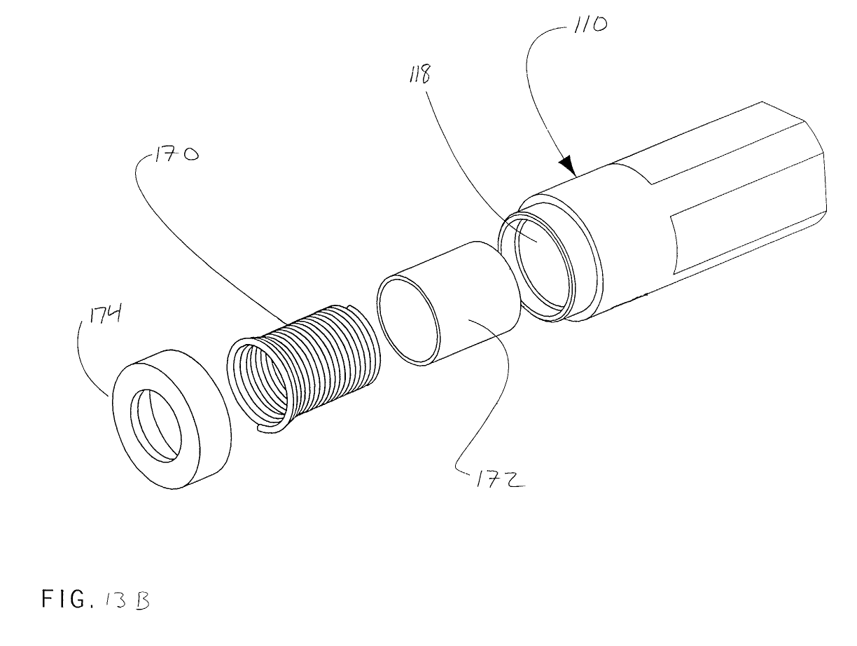

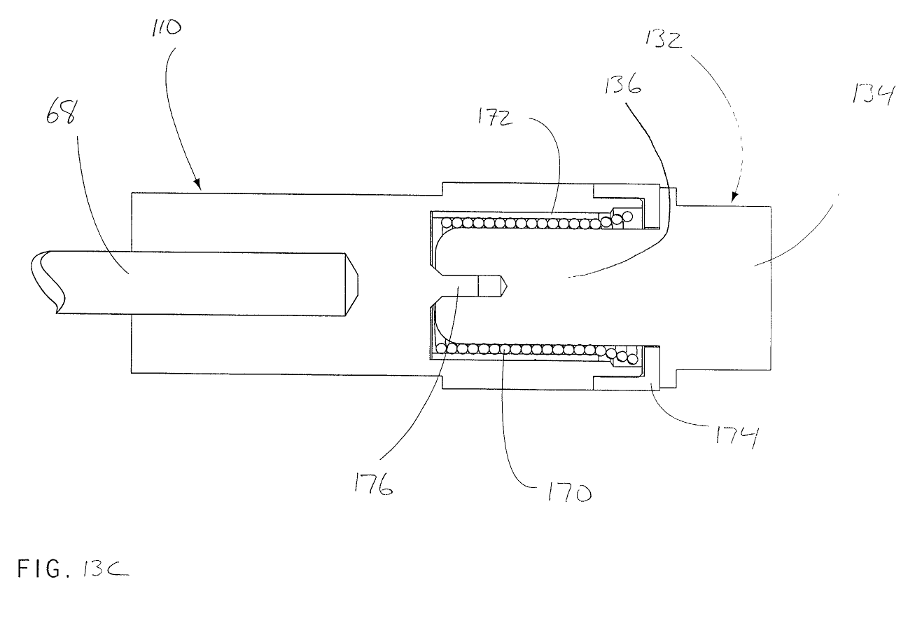

FIGS. 13A to 13C illustrate a fourth alternate embodiment of the present invention, which is similar to the first alternate embodiment described above and in FIGS. 9A-9F, but instead of the conductor spring 122 in portable-side thermal connector 110, a helical conductor spring 170 is disposed in main cavity 118. Thermal transfer material 172, such as Chomerics T646 described above, surrounds helical conductor spring 170 for thermal contact with the inside surface 119 of main cavity 118. A retainer cap 174 is press fit onto the tubular protrusion portion 114 to retain the helical spring 170 and thermal transfer material 172 inside the main cavity 118. An alignment pin 176 protrudes from the back end of main cavity 118, and partially extends down the center of main cavity 118. The plug member 136 of the corresponding dockside thermal connector 132 includes a center alignment hole 178 for engaging with the alignment pin 176.

FIG. 13C illustrates the thermal connectors 110/136 engaged together. The inside effective diameter of helical conductor spring 170 is slightly smaller than the outer diameter of plug member 136, in the non-engaged state. Therefore, when thermal connectors 110/132 are engaged together, and plug member 136 is forcibly inserted inside helical spring 170, wherein a slight unwinding of helical spring 170 occurs and results in a slightly larger effective inner diameter to allow plug member 136 to fit inside helical spring 170. The lateral force between plug member 136 and helical spring 170, the thermal transfer material disposed in the small voids between the helical spring 170 and inside surface 119, and the large amount of surface area of helical spring 170 in contact with plug member 136, results in an efficient thermal conductive path between thermal connectors 110/132.

Summary, Ramifications, and Scope:

As described on the basis of the preferred embodiment, and, in comparison with the conventional art, the portable computer 20 connected to portable computer dock 28 of the present invention achieves dramatic improvements in function and safety as follows:

(1) The transportable size and weight of the portable computer can be reduced due to the exclusion of heat dissipating components.

(2) Because of increased external surface area provided by the dock, as compared with the conventional art, the quantity of heat that can be removed by conduction and convection is greatly increased. Faster and more powerful microprocessors, such as those used in desktop computers, may then be used.

(3) Heat is quickly and efficiently removed from the base of the portable computer, and thus from the heat-sensitive components such as hard drives and CD-ROMs;

(4) Because the present invention cools the internal components better than conventional art in a docked situation, microprocessor speeds may be increased to a point without the inclusion of a forced air system (fan) in the portable housing. The fan that would be required in a similarly configured conventional system, with the entire heat dissipating apparatus included within the base, would be a source of reliability problems, noise, cost, and battery power drain;

6) Since much of the generated heat is transferred out to the dock, the external surfaces that the user can contact remain significantly cooler.

7) Since the system uses an active component as in the thermo-electric unit, a substantially greater thermal differential can be created between the heat-producing components in the portable and the dock, driving much higher heat flow out of the portable.

Although the description above contains many specificities, these should not be construed as limiting the scope of the invention, but merely providing illustration of some of the presently preferred embodiments of this invention. The present invention could be made in a variety of configurations. For example, the dock could be designed without using an active heat-removing system like the thermo-electric unit. The unit could provide substantial thermal benefit by using a larger heat sink with more surface area to produce a decreased low temperature component of the temperature differential. The unit could also be designed with many different types of heat dissipating apparatus in the dock. For example a heat-exchanger or a compressor could be used instead of a thermo-electric unit.

The portable computer is shown with a microprocessor module, but it could be comprised of a motherboard with discrete integrated circuit components including a discrete microprocessor, mounted to the motherboard. The internal heat moving subsystem shown in the preferred embodiment is only connected to the CPU Module. In alternative embodiments, it might also be connected to other hot components in the portable such as the hard disk drive or other hot integrated circuits. In fact, each hot component or functional subsystem might have its own heat moving subsystem and external thermal connector.

The portable computer might take other form factors, such as that of a pen-based portable that includes a touch-sensitive LCD instead of or in addition to, the keyboard and touch-sensitive pointing device. The display might be connected in another manner, for example it might be removable and able to be positioned higher above the portable.

The thermal connection system could also take on other forms. For example, a thermal connection could be made between the bottom side of the portable and a dock with a complimentary surface.

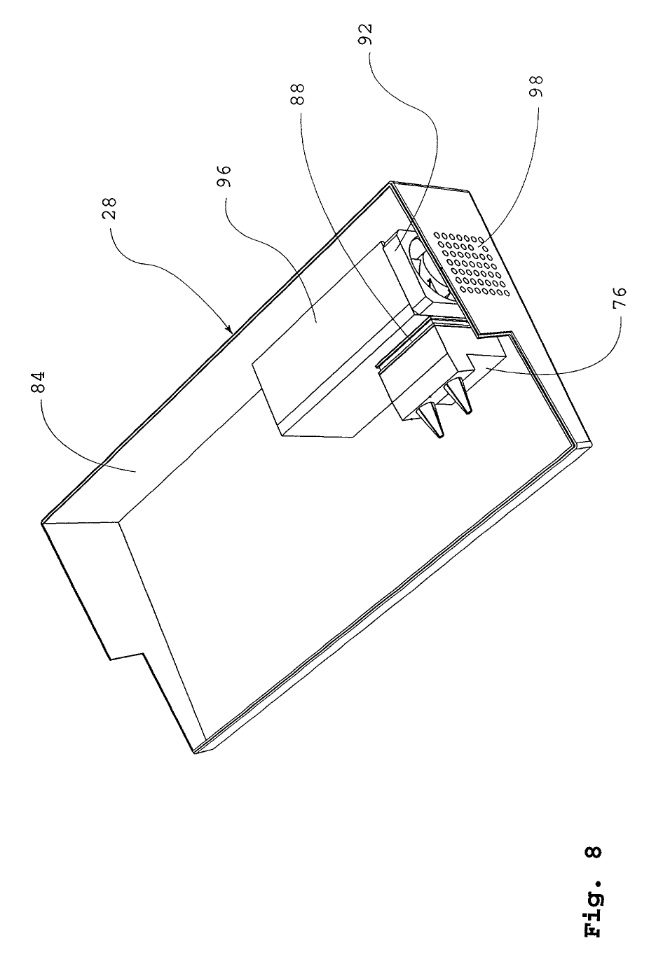

The dock might contain only the thermal dissipation apparatus, as shown in FIG. 8. This dock would be substantially smaller and less expensive than a traditional dock that contains many expansion connectors and the like, and would be used in a location where the user didn't require the extra functionality provided by the expandability, but does require the full computational power of the computer.

The main advantage of the design shown herein is that it allows the portable computer to be smaller in size and weight when transported or used outside of an office environment, and yet provide the highest level of performance when the computer is docked, compared to a conventional portable computer which must contain the entire thermal dissipation subsystem. The performance of this portable system can be the equivalent of a desktop computer system. As shown in the disclosure, the heat is moved out of the portable and more efficiently dissipated in the dock. When the computer is undocked, the thermal state monitor and controller subsystem 35 limits the amount of power, and thus heat, that the computer can output. This is a minority of the time that the portable is used. The portable computer can be lighter and smaller in size because it is not burdened by the inclusion of increasingly numerous and sizable thermal dissipation components. Because docks are used in an environment where there is access to AC power, the thermal dissipation system in the dock can be actively cooled, such as with a thermo-electric unit and a fan, whereby heat is much more effectively dissipated to the surrounding environment. Furthermore, since the dock is located on the desktop, it can be designed with more surface area with which to dissipate the heat that is delivered to it from the portable. This increase in surface area allows the dock to efficiently dissipate more heat than is otherwise possible, even if the dock solely relied on convective transfer of heat to the surrounding environment.

Another advantage of this system is that the portable can be cooled to a much lower temperature when it is in the dock, providing the user with cooler surfaces, such as the palm-rests, thereby increasing the comfort of the user.

Still another advantage is that because the internal temperatures inside the computer can be kept low due to the efficiency of the cooling apparatus in the dock, heat sensitive components inside the portable can be kept cooler, and will thus be more reliable. The dock can also be optimized for better heat transfer. For any electronic device, the top upward facing and side surfaces are the most efficient surfaces to dissipate heat through natural convection. On a portable computer in operation, the largest upward facing surface is the palm rest area, which is in constant contact with the user and thus cannot be taken to high temperatures to promote heat transfer to the air. The dock on the other hand, is typically not touched by the user and can thus maintain hotter surfaces.

The invention presented herein also provides for an increase in performance of the entire system including media, video subsystems, input devices, and the like, in addition to protecting the microprocessor from damage.

The invention provided for herein can also lower the manufacturing and development costs associated with portable computers. Because the majority of heat dissipating components exists in the dock where there is more space available, their design does not require a large engineering effort to miniaturize and configure them, resulting in a lower component cost. Likewise, since there are less components to design into the portable and less difficult thermodynamic problems to solve, a portable incorporating the system disclosed herein is less costly to develop.

The present invention is unique and unobvious in that it includes a thermal sensing and control means that is used in conjunction with a removable heat dissipation means, the combination of which allows for an increase in system performance, and a decrease in the size and weight of the system when transported.

It is to be understood that the present invention is not limited to the embodiments described above and illustrated herein, but encompasses any and all variations falling within the scope of the appended claims. For example, male and female type connectors can be swapped (i.e. the portable side thermal connectors in the computer could be disposed in the portable computer dock, and the dock-side thermal connectors in the dock could be disposed in the portable computer). Further, the thermal conductor springs in all the embodiments can be swapped to the opposing element (i.e. for the embodiment in FIG. 9, thermal conductor spring 122 could be attached to a spring channel formed on the outer surface of plug member 136 instead of the spring channel formed on inner surface 119 of cavity 118).

What is claimed is:

1. A computer system comprising:
a portable computer that includes:
a heat producing component, and
a first thermal connector thermally connected to the heat producing component;
a dock assembly, removably engagable with the portable computer, including:
a heat dissipating apparatus, and
a second thermal connector, thermally connected to the heat dissipating apparatus, and removably engagable with the first thermal connector;
the first thermal connector comprises one of a plug member and a first cavity, wherein the plug member has an outer surface and the first cavity has an inner surface;
the second thermal connector comprises the other of the plug member and the first cavity;
a first spring member secured to one of the inner surface of the first cavity and the outer surface of the plug member such that when the first and second thermal connectors engage each other by the first cavity receiving the plug member, the first spring member contacts with, and forms a thermal connection between, the outer surface of the plug member and the inner surface of the first cavity; and
wherein when the portable computer is engaged with the dock assembly, the first and second thermal connectors engage each other so that heat from the heat producing component is conducted to the heat dissipating apparatus via the first and second thermal connectors.

2. The computer system of claim 1, wherein the first spring member includes:
a pair of annular bands; and
a concave annular section extending between the pair of annular bands, wherein when the first cavity receives the plug member, the annular bands are pressed against the one of the inner surface of the first cavity and the outer surface of the plug member, and the concave annular section is pressed against the other of the inner surface of the first cavity and the outer surface of the plug member.

3. The computer system of claim 2, wherein the concave annular section includes a plurality of slots, and wherein the annular section flexes as the first cavity receives the plug member.

4. The computer system of claim 2, wherein the plug member has a radiussed front edge.

5. The computer system of claim 2, further comprising:
thermal transfer material disposed on the first spring member to facilitate conduction of heat between the first spring member and the one of the inner surface of the first cavity and the outer surface of the plug member.

6. The computer system of claim 2, further comprising:
a first channel formed in the one of the inner surface of the first cavity and the outer surface of the plug member, wherein the annular bands of the first spring member are disposed in the channel for securing the first spring member.

7. The computer system of claim 1, further comprising:
at least one additional spring member secured to the one of the inner surface of the first cavity and the outer surface of the plug member such that when the first and second thermal connectors engage each other by the first cavity receiving the plug member, the at least one additional spring member contacts with, and forms a thermal connection between, the outer surface of the plug member and the inner surface of the first cavity.

8. The computer system of claim 7, wherein the first spring member and the at least one additional spring member each include:
a pair of annular bands; and
a concave annular section extending between the pair of annular bands, wherein when the first cavity receives the plug member, the annular bands are pressed against the one of the inner surface of the first cavity and the outer surface of the plug member, and the concave annular section is pressed against the other of the inner surface of the first cavity and the outer surface of the plug member.

9. The computer system of claim 8, wherein for each of the first spring member and the at least one additional spring member the concave annular section includes a plurality of slots, and wherein the annular section flexes as the first cavity receives the plug member.

10. The computer system of claim 8, further comprising:
a plurality of channels formed in the one of the inner surface of the first cavity and the outer surface of the plug member, wherein each of the channels contain the annular bands of one of the first spring member and the at least one additional spring member.

11. The computer system of claim 1, wherein:
the first cavity includes a post that extends therethrough, the post having an outer surface;
the plug member includes a second cavity for receiving the post when the first and second thermal connectors engage each other, the second cavity has an inner surface;
a second spring member secured to one of the outer surface of the post and the inner surface of the second cavity such that when the first and second thermal connectors engage each other by the second cavity receiving the post, the second spring member contacts with, and forms a thermal connection between, the outer surface of the post and the inner surface of the second cavity; and
wherein when the portable computer is engaged with the dock assembly, the first and second thermal connectors engage each other so that heat from the heat producing component is conducted to the heat dissipating apparatus via the first and second thermal connectors.

12. The computer system of claim 11, wherein:
the first spring member includes:
a first pair of annular bands; and
a first concave annular section extending between the first pair of annular bands, wherein when the first cavity receives the plug member, the first pair of annular bands are pressed against the one of the inner surface of the first cavity and the outer surface of the plug member, and the first concave annular section is pressed against the other of the inner surface of the first cavity and the outer surface of the plug member; and
the second spring member includes:
a second pair of annular bands; and
a second concave annular section extending between the second pair of annular bands, wherein when the second cavity receives the post, the second pair of annular bands are pressed against the one of the outer surface of the post and the inner surface of the second cavity, and the second concave annular section is pressed against the other one of the outer surface of the post and the inner surface of the second cavity.

13. The computer system of claim 12, wherein the first and second concave annular sections each include a plurality of slots, and wherein the first and second annular sections each flex as the first and second thermal connectors engage each other.

14. The computer system of claim 12, further comprising:
thermal transfer material disposed on the first and second spring members to facilitate conduction of heat.

15. The computer system of claim 12, further comprising:
a first channel formed in the one of inner surface of the first cavity and the outer surface of the plug member, wherein the first pair of annular bands of the first spring member are disposed in the first channel; and
a second channel formed in the one of the outer surface of the post and the inner surface of the second cavity, wherein the second pair of annular bands of the second spring member are disposed in the second channel.

16. The computer system of claim 1, wherein the first spring member is secured to the inner surface of the first cavity and is helically shaped having an inside diameter slightly smaller than an outer diameter of the plug member, such that when the first and second thermal connectors are engaged together, the plug member forcibly inserts inside helical spring causing an unwinding of the helical spring and an expansion of the inside diameter.

17. The computer system of claim 16, further comprising:
a retainer cap partially covering an open end of the first cavity for retaining the helically shaped spring inside the cavity.

18. The computer system of claim 16, further comprising:
an alignment pin partially extending down a center of the first cavity; and
center alignment hole formed in the plug member for engaging with the alignment pin as the first and second thermal connectors engage together.

19. The computer system of claim 16, further comprising:
thermal transfer material disposed on the first spring member to facilitate conduction of heat between the first spring member and the inner surface of the first cavity.

20. A computer system comprising:
a portable computer that includes:
a heat producing component, and
a first thermal connector thermally connected to the heat producing component;
a dock assembly, removably engagable with the portable computer, including:
a heat dissipating apparatus, and
a second thermal connector, thermally connected to the heat dissipating apparatus, and removably engagable with the first thermal connector;
the first thermal connector comprises one of a plug member and a cavity, wherein the plug member has an outer surface and the cavity has an inner surface;
the second thermal connector comprises the other of the plug member and the cavity;
the cavity includes a first and a second protrusion extending from the inner surface and into the cavity, the first and second protrusions are positioned to oppose each other so that the cavity has an H-shaped inner surface;
the plug member includes a pair of prongs connected together with a cross member so that the plug member has an H-shaped outer surface, wherein when the first and second thermal connectors engage each other by the cavity receiving the plug member, the outer surface of the plug member contacts with, and forms a thermal connection with, the inner surface of the cavity; and
wherein when the portable computer is engaged with the dock assembly, the first and second thermal connectors engage each other so that heat from the heat producing component is conducted to the heat dissipating apparatus via the first and second thermal connectors.

21. The computer system of claim 20, wherein the inner surface of the cavity and the outer surface of the plug member are tapered relative to each other, so that a lateral force between the inner and outer surfaces increases as the plug member is inserted deeper into the cavity.

22. The computer system of claim 20, wherein the cavity is formed by:
an upper member having a first pair of channels formed therein that are separated by the first protrusion;
a lower member having a second pair of channels formed therein that are separated by the second protrusion;
wherein the upper member is positioned to face the lower member to that the first and second pair of channels, and the first and second protrusions, form the H-shaped inner surface.

23. A computer system, comprising:
a portable computer that includes:
a heat producing component,
a first thermal connector, and
a heat conducting apparatus thermally connected between the heat producing component and the first thermal connector; and
a dock assembly, removably engagable with the portable computer, including:
a heat dissipating apparatus, and
a second thermal connector, thermally connected to the heat dissipating apparatus, and removably engagable with the first thermal connector;
wherein:
when the portable computer is engaged with the dock assembly, the first and second thermal connectors engage each other so that heat from the heat producing component is conducted to the heat dissipating apparatus,
the first thermal connector comprises one of a protrusion and a cavity,
the second thermal connector comprises the other of the protrusion and the cavity, such that when the first and second thermal connectors engage each other, an interior surface of the cavity contacts an outer surface of the protrusion to form a thermal contact therebetween, and
the first and second thermal connectors are conical in shape.

24. A computer system, comprising:
a portable computer including a plurality of heat-producing elements, an internal heat moving apparatus thermally connected to at least one of said heat-producing elements, and a thermal state monitor and control means that permits said heat-producing element to operate at the highest functional limit;
a dock containing a heat dissipating apparatus;
a two-sided, re-connectable thermal connection means for thermally connecting said heat-moving apparatus in said portable computer with said heat dissipating apparatus in said dock when said computer is docked, said re-connectable thermal connection comprising:
a first side comprising at least one concavity,
a second side comprising at least one correspondingly shaped split protrusion, wherein said split in said protrusion permits said protrusion to comply against said inside surface of said concavity for maximum surface contact;
wherein the first and second thermal connectors are conical in shape
